(19) United States
(12) Patent Application Publication
(10) Pub. No.: US 2007/0243044 A1
(43) Pub. Date: Oct. 18, 2007

(54) Wear resistant nut

(76) Inventor: Chin-Chiu Chen, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/584,852

(22) Filed: Oct. 23, 2006

(30) Foreign Application Priority Data
Mar. 29, 2006 (TW) 095205234

(51) Int. Cl. F16B 37/00

(52) U.S. Cl. 411/427

(57) ABSTRACT

A nut includes a body, a centrally defined through hole defined through the body and an inner threading formed on an inner periphery defining the through hole. A wear resistant coating is coated on an outer periphery of the body and the inner periphery of the through hole such that load endurance of the nut is increased.

### BACKGROUND OF THE INVENTION

1. Field of the Invention

The present invention relates to a wear resistant nut, and more particularly to a wear resistant nut having a coating provided on the outer periphery of the nut such that wear endurance of the nut is increased.

2. Description of the Prior Art

A nut is normally used with a bolt and a washer to ensure engagement of two workpiece through which the bolt extends. In order to prolong the life span of the nut, a rustproof or anticorrosion coating is electroplated on an outer periphery of the nut. Therefore, the nut is able to resist the corrosion from water or corrosion from acid. Beside the electroplating process of the rustproof or anticorrosion coating, a general problem occurs when the nut is being rotated to tighten the engagement between workpiece. That is, to ensure the engagement of the two workpiece, an external force is applied to rotate the nut. However, due to the material of which the nut is made, the operator may not be able to tighten the nut as secure as expected for fear of damage to the nut. As a result, the engagement between these two workpiece is somewhat loose and the application of the workpiece is rather awkward.

To overcome the shortcomings, the present invention tends to provide an improved wear resistant nut to mitigate the aforementioned problems.

### SUMMARY OF THE INVENTION

The primary objective of the present invention is to provide a wear resistant coating on a outer periphery of the nut to increase load endurance of the nut.

In one aspect of the present invention, the wear resistant coating is an alloy composed of nickel and cobalt.

In yet another aspect of the present invention, the wear resistant coating is composed of carbide tungsten.

A further aspect of the present invention is that the wear resistant coating is composed of Teflon®.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the nut of the present invention;

FIG. 2 is a cross sectional view of the nut of the present invention; and

FIG. 3 is an operational view showing the application of the nut with a workpiece.

### DETAILED DESCRIPTION OF THE PREFERRED EMBODIMENT

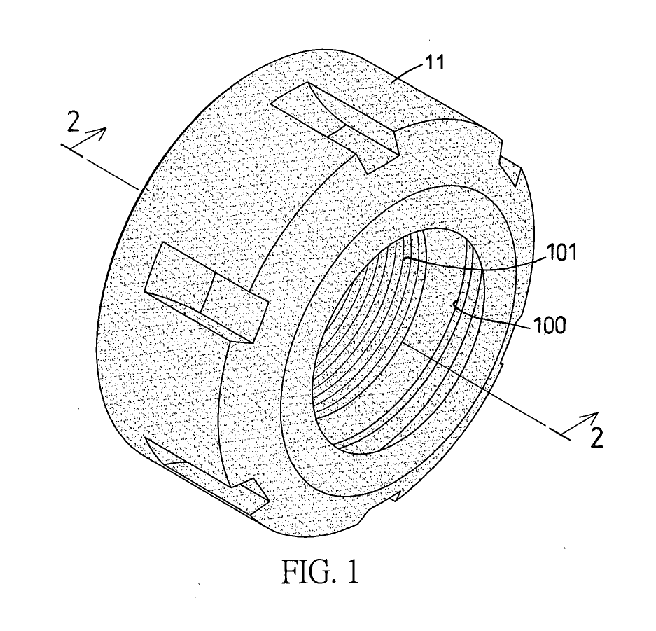

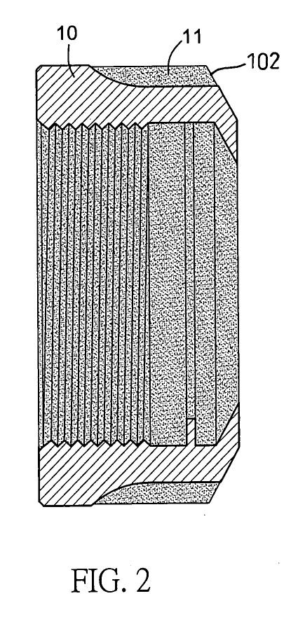

With reference to FIGS. 1 and 2, it is noted that the nut in accordance with the present invention includes a body (10) with a centrally defined through hole (100) defined through the body (10) and an inner threading (101 ) defined in an inner periphery defining the through hole (100).

It is noted that the body (10) has cutouts (102) defined in an outer periphery of the body (10). The cutouts (102) longitudinally extends the outer periphery of the body (10) and terminates at about ⅔ of a height (H) of the body (10). A wear resistant coating (11) is coated or electroplated the outer and inner periphery of the body (10) so that not only the wear resistant coating (11) is allover the outer periphery of the body (10), but also the wear resistant coating (11) is spread on the inner periphery defining the through hole (100). That is, the wear resistant layer (11) is spread on the inner threading (10).

In a preferred embodiment, the wear resistant coating (11) is an alloy of nickel and cobalt.

In yet another embodiment of the present invention, the wear resistant coating (11) is composed of carbide tungsten.

A further embodiment of the present invention is that the wear resistant coating (11) is composed of Teflon®.

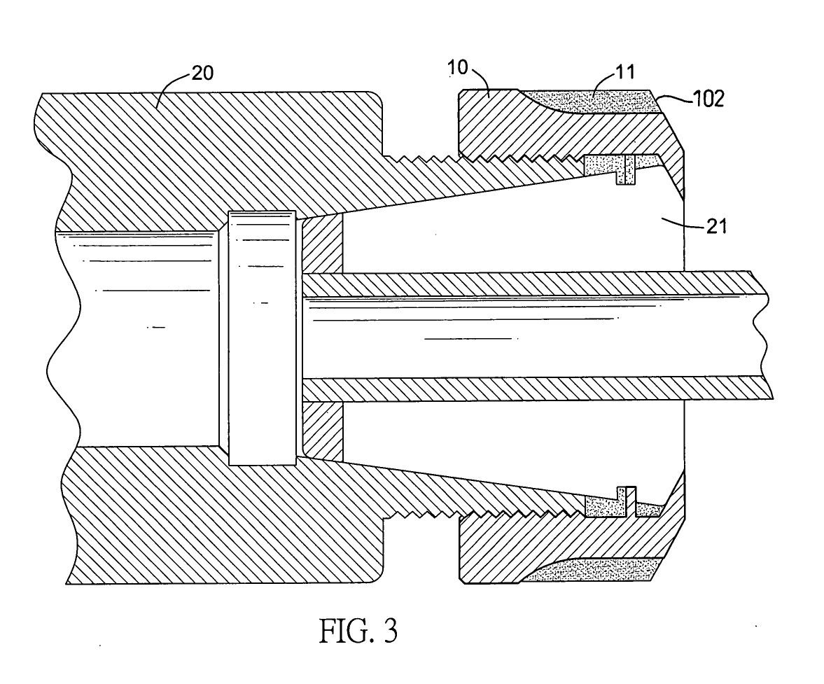

With reference to FIG. 3, it is noted that when the nut of the present invention is threadingly connected to a workpiece (20) having an element (21) slidably received inside the workpiece (20), in order to secure the position of the element (21) inside the workpiece (20), the operator is able to tighten the nut of the present invention with a greater force. Due to the provision of the wear resistant coating (11), the nut has greater load endurance such that the nut of the present invention lasts for a long period of time under influence of large load (force).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a nut having a body, a centrally defined through hole defined through the body and an inner threading formed on an inner periphery defining the through hole, wherein the improvement comprises:
a wear resistant coating is coated on an outer periphery of the body and the inner periphery of the through hole such that load endurance of the nut is increased.

2. The nut as claimed in claim 1, wherein the wear resistant coating consists essentially of an alloy composed of nickel and cobalt.

3. The nut as claimed in claim 1, wherein the wear resistant coating consists essentially of Teflon®.
